(19) United States
(12) Patent Application Publication
(10) Pub. No.: US 2025/0142264 A1
(43) Pub. Date: May 1, 2025

(54) PIEZOELECTRIC SPEAKER AND METHOD FOR MANUFACTURING THE SAME

(71) Applicant: National Tsing Hua University, Hsinchu (TW)

(72) Inventors: Ting Chou Wei, Hsinchu (TW); Chia-Hao Lin, Hsinchu (TW); Zih-Song Hu, Hsinchu (TW); Shu-Wei Chang, Hsinchu (TW); Sung Cheng LO, Hsinchu (TW); Weileun Fang, Hsinchu (TW)

(73) Assignee: National Tsing Hua University, Hsinchu (TW)

(21) Appl. No.: 18/411,446

(22) Filed: Jan. 12, 2024

(30) Foreign Application Priority Data
Oct. 31, 2023 (TW) 112141860

(51) Int. Cl. H04R 17/00; H04R 31/00

(52) U.S. Cl. CPC H04R 17/00; H04R 31/003; H04R 31/006; H04R 2400/11

(57) ABSTRACT

The present invention provides a piezoelectric speaker, including: a frame; a cantilever plate actuator disposed on the frame; a spring connected to the frame and the cantilever plate actuator; and a central diaphragm connected to the spring, wherein when the cantilever plate actuator vibrates, the central diaphragm vibrates with the spring.

### CROSS REFERENCE TO RELATED APPLICATIONS

The application claims the benefit of Taiwan Patent Application No. 112141860, filed on Oct. 31, 2023, at the Taiwan Intellectual Property Office, the disclosures of which are incorporated herein in their entirety by reference.

### FIELD OF THE INVENTION

The present invention relates to a speaker, and in particular to a piezoelectric speaker used in In-ear Headphones.

### BACKGROUND OF THE INVENTION

As consumer electronics become more sophisticated and miniaturized, microelectromechanical systems (MEMS) are also receiving more attention. Lead zirconate titanate (Pb(ZrₓTi₁₋ₓ)O₃, PZT) material has good piezoelectric properties and is easy to combine with silicon micro fabrication, so it is widely used in fields such as micro speakers (Piezoelectric speakers).

In the application of in-ear headphones, there are two main technologies: Dynamic Drivers (DD) and Balanced Armatures (BA). Due to the mature manufacturing process of the dynamic driver, it has the advantages of low cost, wide audio frequency band (20˜20 kHz) and stable response. However, the Joule heat provided by the voice coil element results in poor power consumption, and the large diaphragm size also limits its potential for miniaturization. As for the balanced armature technology, it is also driven by the Lorentz force. It has a relatively small size, high stiffness, and good treble (high frequency) band performance. However, its shortcomings are narrow bandwidth and high assembly requirements.

Piezoelectric speakers are a better alternative to balanced armature technology, wherein a spring-diaphragm structure provides lower total harmonic distortion, but requires complex electrical wiring and out-of-phase driving.

### SUMMARY OF THE INVENTION

The invention provides a micro speaker with a special structural design that can increase the up and down displacement of the central diaphragm and reduce residual stress while meeting the requirements of small size and low power consumption. In other words, the present invention uses the excitation of the in-phase periodic bending of each cantilever plate type actuator to cause the piston movement of the central diaphragm and the folding spring to output sound pressure. In addition, despite the stiffening effect of the prestress, the elastic folding spring relieves the residual stress in the brake diaphragm.

In accordance with one aspect of the present invention, a piezoelectric speaker is disclosed. The piezoelectric speaker includes a frame; a cantilever plate actuator disposed on the frame; a spring connected to the frame and the cantilever plate actuator; and a central diaphragm connected to the spring, wherein when the cantilever plate actuator vibrates, the central diaphragm vibrates with the spring.

In accordance with another aspect of the present invention, a method for manufacturing a piezoelectric speaker is disclosed. The method includes the steps of: providing a substrate; forming a bottom electrode layer on the substrate; forming a piezoelectric layer on the bottom electrode layer, wherein the substrate, the bottom electrode layer and the piezoelectric layer form a precursor having a central region and an edge area; etching the piezoelectric layer in the edge area; forming and patterning a top electrode layer on the edge area; etching the piezoelectric layer, the bottom electrode layer and an upper portion of the substrate located in the central region to form a cantilever plate actuator; and etching a lower portion of the substrate to form a frame, a spring connected to the frame and the cantilever plate actuator, and a central diaphragm connected to the spring.

In accordance with a further aspect of the present invention, a piezoelectric speaker is disclosed. The piezoelectric speaker includes a piezoelectric element; and a substrate carrying thereon the piezoelectric element, and including: a central diaphragm disposed in the center of the substrate to generate a second vibration in response to a first vibration of the piezoelectric element; and an amplitude enhancement mechanism disposed on the central diaphragm to enhance a vibration amplitude of the second vibration.

### BRIEF DESCRIPTION OF THE DRAWINGS

FIG. 1(a) is a perspective view of the piezoelectric speaker according to the embodiment of the present invention.

FIG. 1(b) is an enlarged view of the spring portion of the piezoelectric speaker according to the embodiment of the present invention.

FIG. 2 is a vibration schematic diagram of the piezoelectric speaker according to the embodiment of the present invention.

FIG. 3 is a simulation diagram of the frequency response of the piezoelectric speaker at 20 KHz according to the embodiment of the present invention.

FIG. 4(a)-4(d) are cross-sectional views showing structural changes of the piezoelectric speaker after performing four processing steps of the piezoelectric speaker manufacturing method.

FIG. 5 shows the frequency response of the piezoelectric speaker under unipolar AC drive (0.7 Vrms driving) with different DC bias voltages according to the embodiment of the present invention.

FIG. 6 shows the frequency response diagram of the piezoelectric speaker under different AC driving voltages of 10 VDC according to the embodiment of the present invention.

FIG. 7 is a total harmonic distortion diagram of the piezoelectric speaker under a fixed AC driving voltage and DC bias environment according to the embodiment of the present invention.

FIG. 8 is a linearity diagram showing the frequency sound pressure of the piezoelectric speaker under different frequency responses according to the embodiment of the present invention.

### DETAILED DESCRIPTION OF THE PREFERRED EMBODIMENTS

The technical content, features and effects of the present invention will be clearly presented by the following detailed descriptions of preferred embodiments.

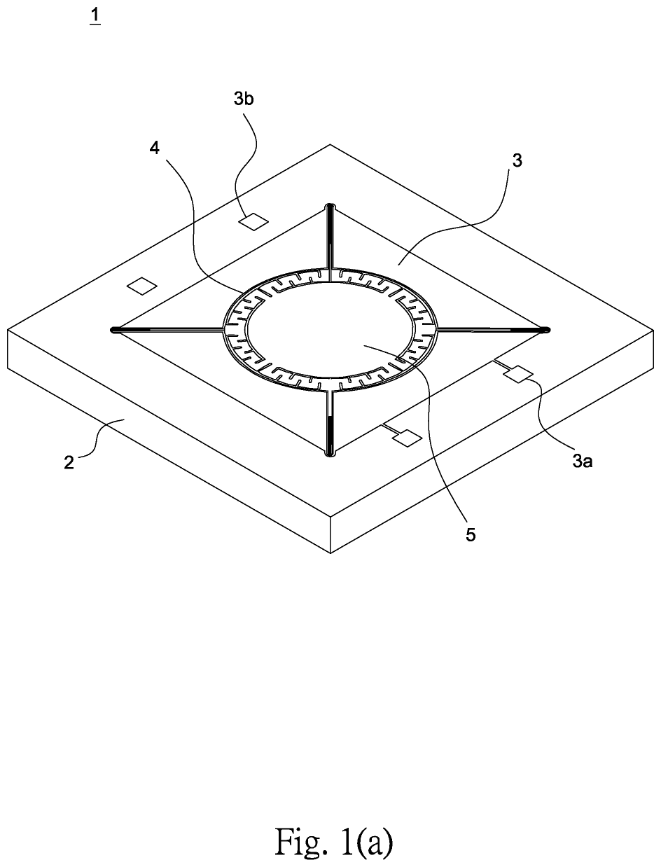

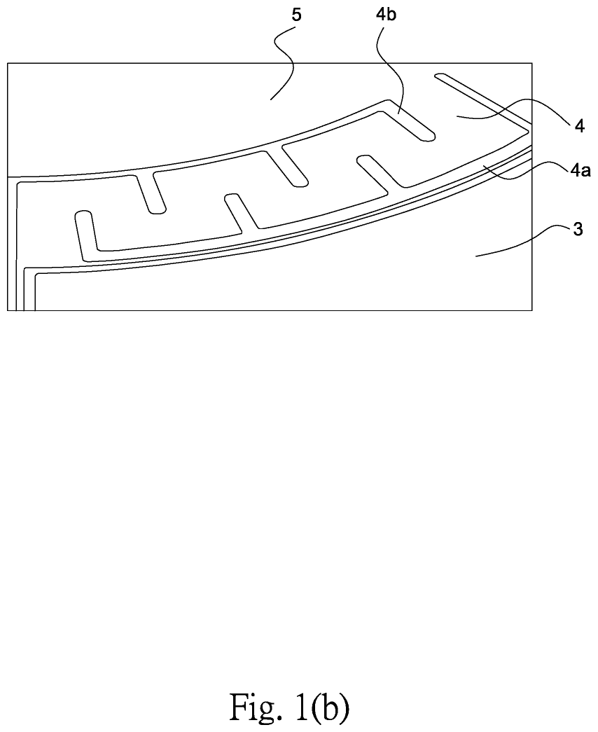

Please refer to FIG. 1(a). FIG. 1(a) is a perspective view of the piezoelectric speaker 1 according to the embodiment of the present invention. The piezoelectric speaker 1 includes a frame 2, a cantilever plate actuator 3, a spring 4 and a central diaphragm 5. Four cantilever plate actuators 3 are disposed on the frame 2. The cantilever plate actuators 3 are made of piezoelectric material and have a vibrating end and a fixed end, and the fixed end is connected to the frame 2. The cantilever plate actuator 3 is connected to a feed point 3a and a ground point 3b. A driving signal (for example, a driving voltage signal) is applied to the cantilever plate actuator 3 through the feed point 3a, causing the vibrating end of the cantilever plate actuator 3 to vibrate. The cantilever plate actuators 3 are electrically connected to each other and the feed point 3a. Although it is preferable to provide two feed points 3a and ground points 3b in the embodiment, only one feed point and ground point are acceptable.

Please refer to FIG. 1(b). FIG. 1(b) is an enlarged view of the spring portion of the piezoelectric speaker according to the embodiment of the present invention. It can be seen from FIG. 1(b) that the spring 4 is connected to the vibration end of the cantilever plate actuator 3. The spring 4 has a plate structure and is made of a plurality of slits 4a and 4b. The plurality of slits 4a and 4b are two rows facing each other but not connected. The spring 4 and the central diaphragm 5 are formed of the same material, wherein the part surrounded by the slits 4a and 4b is the spring 4, and the rest is the central diaphragm 5. In the embodiment, the spring 4 is a meandering spring formed of a plurality of slits, and the slits 4a and 4b can be formed of a plurality of U-shaped or C-shaped slits. However, the shape of the spring 4 is not particularly limited. As long as the spring 4 can be connected to the central diaphragm 5 and the cantilever plate actuator 3, and exert the spring function between the central diaphragm 5 and the cantilever plate actuator 3. For example, the slit can be V-shaped, arc-shaped and other shapes.

In the embodiments of FIGS. 1(a) and 1(b), the central diaphragm 5 is formed in a circular shape, and the spring 4 is formed in an annular structure with a circular outer circumference. Each cantilever plate actuator 3 corresponds to the circular structure of the central diaphragm 5 and the square structure of the frame 2, and is formed into a trapezoid-like shape with an arc edge. The above various shapes are only one embodiment and are not limited thereto.

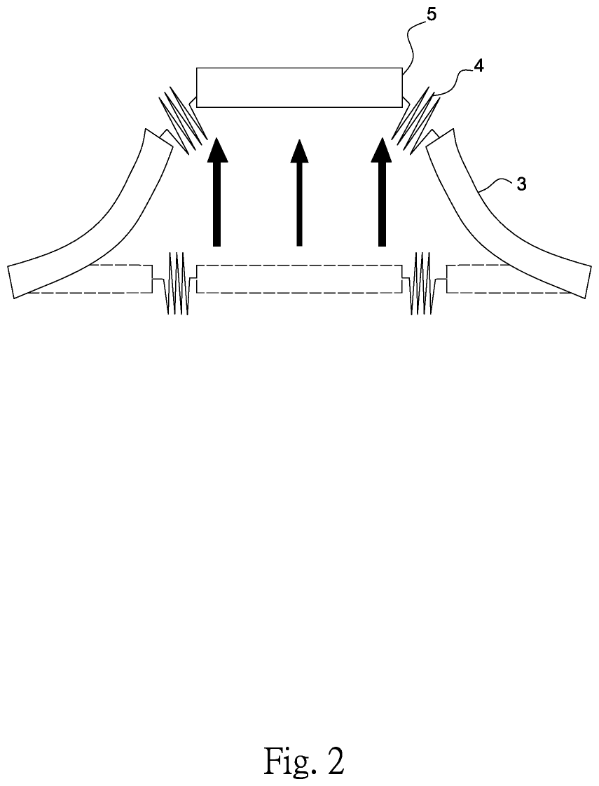

Please refer to FIG. 2. FIG. 2 is a vibration diagram of a piezoelectric speaker according to the embodiment of the present invention. It can be seen from FIG. 2 that when the cantilever plate actuator 3 vibrates upward, it will drive the central diaphragm 5 vibrates upward with the spring 4 together, and then return downward to its original position. This repeated piston movement mode causes the piezoelectric speaker 1 to produce sound. The spring 4 is used to release the residual stress given to the central diaphragm 5 by the cantilever plate actuator 3.

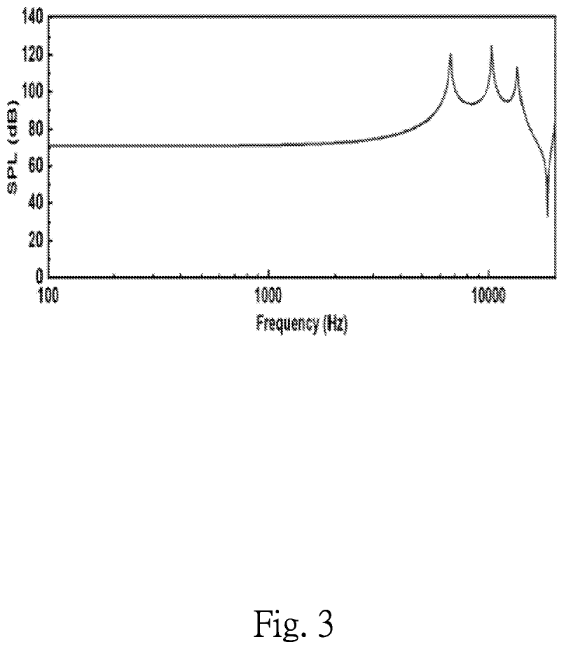

Please refer to FIG. 3. FIG. 3 is a simulation diagram of the frequency response of the piezoelectric speaker at 20 KHz according to the embodiment of the present invention. The first and third sound pressure level (SPL) peaks are caused by the Helmholtz resonance of the human ear simulator, while the second SPL peak at 11.2 kHz is the piston movement mode of the embodiment and has high sound pressure performance. On the other hand, the lowest sound pressure level trough at 17.3 kHz is caused by the tilt of the spring to the central diaphragm structure.

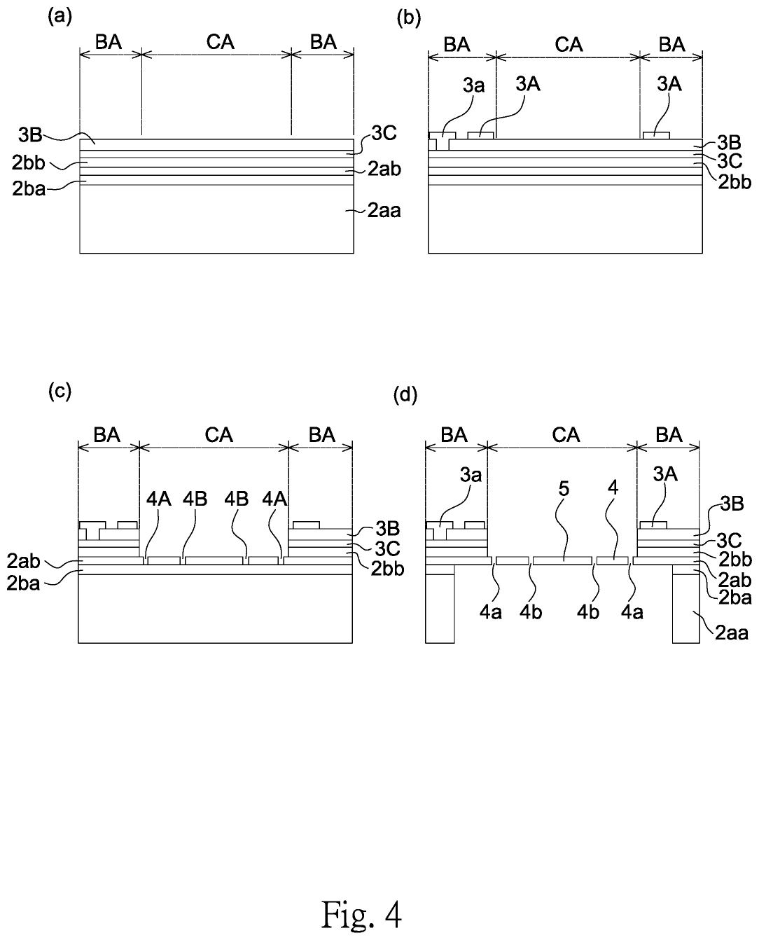

Please refer to FIG. 4(a)-4(b). FIG. 4(a)-4(d) show cross-sectional views of the structural changes of the micro speaker after performing four processing steps of the piezoelectric speaker manufacturing method.

As shown in FIG. 4(a), on a silicon layer 2aa, a silicon dioxide layer 2ba is deposited by plasma chemical vapor deposition (PECVD), and then the step is repeated on the silicon dioxide layer 2ba to form a silicon layer 2ab and a silicon dioxide layer 2bb, and then a double-layer structure of the silicon layer and the silicon dioxide layer is formed. The silicon layer 2aa, the silicon dioxide layer 2ba, the silicon layer 2ab and the silicon dioxide layer 2bb integrate into a substrate. Therefore, the substrate includes the silicon layer 2aa, the silicon dioxide layer 2ba, the silicon layer 2ab and the silicon dioxide layer 2bb in order from bottom to top. The substrate is the precursor of the frame 2. Then, a bottom electrode layer 3C is deposited by sputtering on the uppermost silicon dioxide layer 2bb. Next, the piezoelectric material layer 3B is deposited on the bottom electrode layer 3C using the Sol-Gel Process. The precursor formed by the substrate, bottom electrode layer 3C and piezoelectric layer 3B has a central area CA and an edge area BA.

Then, as shown in FIG. 4(b), after etching the piezoelectric material layer 3B in the edge area BA by wet etching, the top electrode layer 3A is deposited on the piezoelectric material layer 3B with an electron gun (E-gun) and then the top electrode layer 3A is patterned. The top electrode layer 3A thereby forms a feed point 3a to which the bottom electrode 3C is connected. At this time, the top electrode layer 3A, the piezoelectric material layer 3B and the bottom electrode layer 3C that have not been further processed are the precursors of the cantilever plate actuator 3.

Then, in order to maintain the flatness of the central diaphragm, other layers including the electrode layer and the piezoelectric layer are removed to reduce pre-deformation. As shown in FIG. 4(c), the piezoelectric material layer 3B in the central area CA, the upper silicon dioxide layer 2bb and the bottom electrode layer 3C in the central area CA are removed by inductively coupled plasma reactive ion etching (ICP-RIE). Then, a part of the second silicon layer 2ab in the central area is removed by deep reactive ion etching (DRIE). A plurality of grooves 4A and 4B are formed in the second silicon layer 2ab, so that the second silicon layer 2ab becomes the precursor of the spring 4 and the central diaphragm 5 connected to the spring 4, and the plurality of grooves 4A and 4B also become the precursors of the plurality of slits 4a and 4b.

Finally, as shown in FIG. 4(d), a portion of the lower first silicon layer 2aa and the first silicon dioxide layer 2ba is removed by deep reactive ion etching (DRIE) to form the frame 2, the cantilever plate actuator 3, and the spring 4, a plurality of slits 4a, 4b and the central diaphragm 5. In FIG. 4(d), the frame 2 includes the first silicon layer 2aa, the first silicon dioxide layer 2ba, the second silicon layer 2ab and the second silicon dioxide layer 2bb in the edge area BA. In addition, it should be noted that although FIG. 4(d) shows that the formation of the slit 4a causes the spring 4 to separate from the second silicon layer 2ab, and the formation of the slit 4b causes the spring 4 to separate from the central diaphragm 5, this is only a cross-sectional view used to show the existence of gaps 4a and 4b. In fact, the spring 4 is still partially connected to the second silicon layer 2ab and the central diaphragm 5. That is to say, both of the cantilever plate actuator 3 and the spring 4 are connected to the frame 2. The cantilever plate actuator 3 is connected to the second silicon dioxide layer 2bb of the frame 2, and the spring 4 is connected to the second silicon dioxide layer 2ab of the frame 2.

In the embodiment of the present invention, in addition to being made of other typical piezoelectric materials such as AlN, ZnO, TiBaO₃, etc., the piezoelectric material layer 3B is preferably made of PZT (lead zirconate titanate) material. The top electrode layer 3A and the bottom electrode layer 3C can be made of conductive materials. The top electrode layer 3A is made of gold (Au) or chromium (Cr), and the bottom electrode layer 3C is made of platinum (Pt). The piezoelectric material layer 3B is disposed between the top electrode layer 3A and the bottom electrode layer 3C. In this way, the electrical energy is converted into mechanical energy that stretches the piezoelectric material layer by applying a voltage to the electrode layer, thereby generating vibration.

The overall size of the piezoelectric speaker 1 in the embodiment is 4×4 mm², and its chip is 3×3 mm². The chip includes a cantilever plate actuator 3, a spring 4, a central diaphragm 5 and other structures, and its operating frequency is above 10 KHz. Based on this condition, the width of the fixed end of the cantilever plate actuator 3 is 2 mm, the length of the cantilever plate actuator 3 is 314 μm, and the radius of the circular central diaphragm 5 is 551 μm. The width of the slits 4a and 4b of the spring 4 should not exceed 5 μm, and the width of the spring 4 itself needs to be greater than 50 μm.

In the embodiment, the resonant frequency of the piezoelectric speaker is determined by the rigidity of the cantilever plate actuator, the rigidity of the connecting spring and the mass of the central diaphragm, rather than the cantilever plate actuator. Therefore, the resonant frequency of the cantilever plate actuator does not represent the resonant frequency of the piezoelectric speaker. The cantilever plate actuator only provides actuation force but not displacement. When the connecting spring transmits energy to the central diaphragm, the resonant frequency of the cantilever plate actuator itself will be much greater than the resonant frequency of the entire piezoelectric speaker. Under the condition that the component suspension area (i.e., the central diaphragm area) is fixed, changing the length of the slit will affect the equivalent length and width of the connecting spring. That is, a larger slit may make the spring width narrower and the equivalent length longer, the resonant frequency decreases and vice versa. Therefore, the dimensions of the above elements can be adjusted as needed to achieve optimal performance.

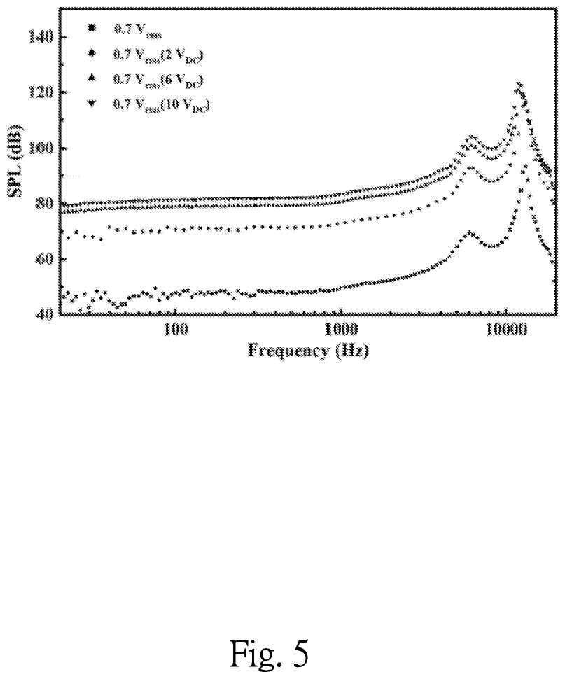

FIG. 5 shows the frequency response under unipolar AC drive (0.7 Vrms drive) with different DC bias voltages. The main purpose of using DC bias is to avoid polarization reversal, and after applying DC bias, the sound pressure level is significantly increased by more than 20 dB. It can be seen from FIG. 5 that the sound pressure level gradually increases as the DC bias voltage increases, and reaches saturation around 8˜10 VDC. These results show that the use of DC bias can not only prevent the problem of polarization reversal, but also improve the piezoelectric constant of the piezoelectric element used in the embodiment of the present invention.

The measurement method in FIG. 5 is explained below. First, a micro speaker wire-bonded on a customized printed circuit board is used as the device under test (DUT). The DUT is then mounted on a standard human ear simulator (G.R.A.S. RA0401) in an anechoic enclosure. When the driving signal is transmitted from the pulse spectrum analyzer (B&K) to the DUT, the sound pressure is generated and the output sound pressure is received by a standard pressure field microphone (G.R.A.S. 40AG) in the human ear simulator. Finally, the sound signal is converted into an electrical signal for recording and analysis.

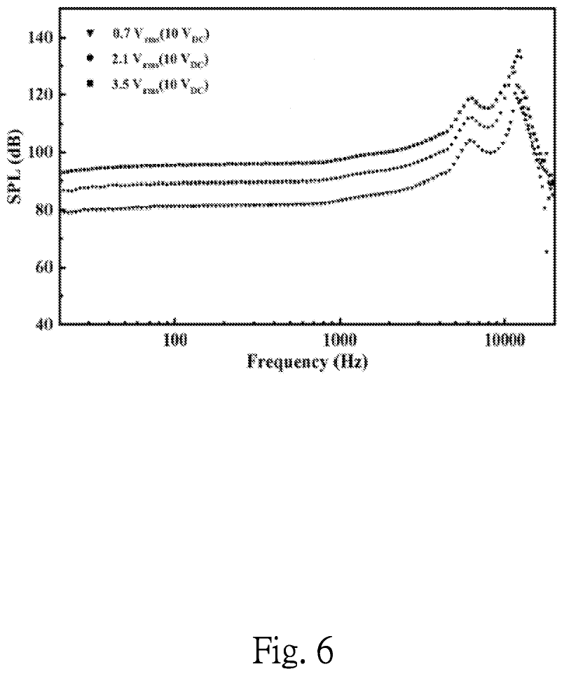

FIG. 6 shows the frequency response diagram of different AC driving voltages at 10 VDC. In the range of 20 Hz˜20 kHz, when the unipolar AC driving voltage is higher than 2.1 Vrms (10 VDC), the sound pressure level approaches 90 dB, and when the unipolar AC driving voltage is 3.5 Vrms (10 VDC), the sound pressure level is even higher than 93 dB.

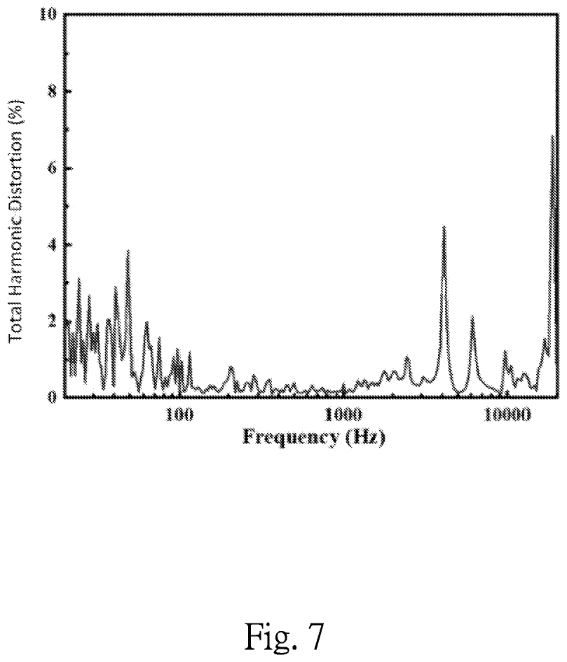

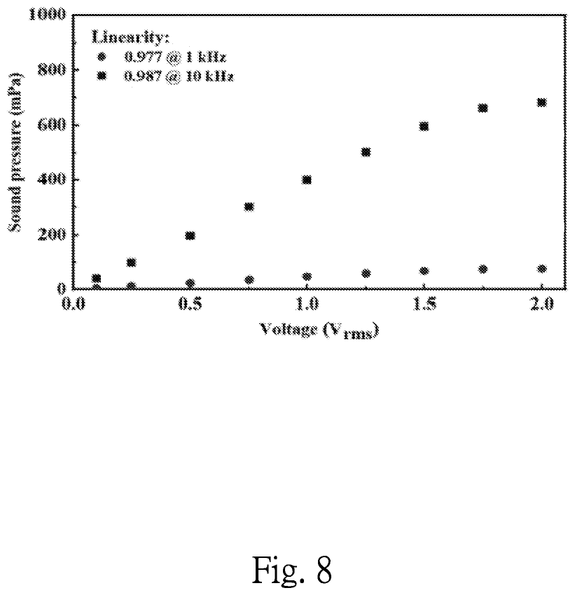

The total harmonic distortion (THD) performance at 0.7 Vrms (10 VDC) of FIG. 6 is shown in FIG. 7. FIG. 7 is a total harmonic distortion diagram of the piezoelectric speaker under a fixed AC driving voltage and DC bias environment according to the embodiment of the present invention. It can be seen from FIG. 7 that when the overall sound pressure level is higher than 80 dB, the embodiment of the present invention can achieve the total harmonic distortion of less than 7%. In addition, when excluding THD peaks caused by acoustic short circuits and subharmonics, the THD in other frequency bands is even lower than 1%, which once again proves the good sound quality of the piezoelectric speaker according to the embodiment of the present invention under the piston movement. FIG. 8 is a linearity diagram showing the frequency sound pressure of the piezoelectric speaker under different frequency responses according to the embodiment of the present invention. FIG. 8 shows that at different frequencies of 1 kHz and 10 kHz, the linearity is 0.977 and 0.987 respectively. This good linearity shows the high stability of the response in the low and high frequency ranges.

Although the frame in the embodiment of the present invention is a rectangle, if necessary, a circular, triangular, polygonal or even irregularly shaped frame with organic curves can be used. In order to match the frame, the cantilever plate actuator in the embodiment of the present invention does not have to be trapezoidal, and any adjustment can be made if necessary. In addition, although the central diaphragm in the embodiment of the present invention is circular, it is not limited to this. If necessary, it can also be adjusted according to the frame and the cantilever plat actuator. Furthermore, although there are four cantilever plate actuators in the embodiment of the present invention, the number is not limited to this and may be two or more. Although the element connecting the central diaphragm is called a spring in the embodiment of the present invention, it is not limited to the spring. As long as it can increase the amplitude of the central diaphragm and reduce the residual stress, it can also be called an amplitude enhancement mechanism. In the embodiment of the present invention, the spring and the central diaphragm are formed of a material the same as that of the first silicon layer of the frame, but it is not limited to this. As long as the amplitude of the central diaphragm can be increased and the residual stress can be reduced, different materials can be used to connect the spring and the central diaphragm with different manufacturing processes.

### EMBODIMENTS

1. A piezoelectric speaker comprising: a frame; a cantilever plate actuator disposed on the frame; a spring connected to the frame and the cantilever plate actuator; and a central diaphragm connected to the spring, wherein when the cantilever plate actuator vibrates, the central diaphragm vibrates with the spring.

2. The piezoelectric speaker according to Embodiment 1, wherein the frame comprises a first silicon layer, a first silicon dioxide layer, a second silicon layer, and a second silicon dioxide layer in order from bottom to top.

3. The piezoelectric speaker according to Embodiments 1-2, wherein the central diaphragm and the spring are formed of a material the same as that of the first silicon layer of the frame.

4. The piezoelectric speaker according to Embodiments 1-3, wherein the cantilever plate actuator comprises a top electrode, a piezoelectric layer and a bottom electrode, wherein: the bottom electrode is connected to the first silicon dioxide layer; the piezoelectric layer is made of a lead zirconate titanate (PZT); the top electrode is made of at least one of gold and chromium; and the bottom electrode is made of platinum.

5. The piezoelectric speaker according to Embodiments 1-4, wherein the spring is a plate having a plurality of slits.

6. The piezoelectric speaker according to Embodiments 1-5, wherein the cantilever plate actuator has a fixed end and a vibrating end, the vibrating end is connected to the spring, and the fixed end is connected to the frame.

7. A method for manufacturing a piezoelectric speaker, comprising the steps of: providing a substrate; forming a bottom electrode layer on the substrate; forming a piezoelectric layer on the bottom electrode layer, wherein the substrate, the bottom electrode layer and the piezoelectric layer form a precursor having a central region and an edge area; etching the piezoelectric layer in the edge area; forming and patterning a top electrode layer on the edge area; etching the piezoelectric layer, the bottom electrode layer and an upper portion of the substrate located in the central region to form a cantilever plate actuator; and etching a lower portion of the substrate to form a frame, a spring connected to the frame and the cantilever plate actuator, and a central diaphragm connected to the spring.

8. The method according to Embodiment 7, wherein: the substrate comprises a first silicon dioxide layer, a first silicon layer, a second silicon dioxide layer and a second silicon layer in order from bottom to top; the substrate has a lower portion and an upper portion, the lower portion comprises the first silicon dioxide layer and the first silicon layer, and the upper portion comprises the second silicon dioxide layer and the second silicon layer; and the central diaphragm and the spring are made of a material the same as that of the first silicon layer of the frame.

9. The method according to Embodiments 7-8, wherein the piezoelectric layer is made of a lead zirconate titanate (PZT); the top electrode layer is made of at least one of gold and chromium; and the bottom electrode layer is made of platinum.

10. The method according to Embodiments 7-9, wherein the spring is a plate having a plurality of slits.

11. The method according to Embodiments 7-10, wherein the cantilever plate actuator has a fixed end and a vibrating end, the vibrating end is connected to the spring, and the fixed end is connected to the frame.

12. A piezoelectric speaker, comprising: a piezoelectric element; and a substrate carrying thereon the piezoelectric element, and comprising: a central diaphragm disposed in the center of the substrate to generate a second vibration in response to a first vibration of the piezoelectric element; and an amplitude enhancement mechanism disposed on the central diaphragm to enhance a vibration amplitude of the second vibration.

13. The piezoelectric speaker according to Embodiment 12, wherein the amplitude enhancement mechanism is formed by a specific slot pattern.

14. The piezoelectric speaker according to Embodiments 12-13, wherein the central diaphragm and the amplitude enhancement mechanism are formed of a material the same as that of the substrate.

15. The piezoelectric speaker according to Embodiments 12-14, wherein: the piezoelectric element has a fixed end and a vibrating end, the vibrating end is connected to the amplitude enhancement mechanism, and the fixed end is connected to the substrate.

16. The piezoelectric speaker according to Embodiments 12-15, wherein the piezoelectric element comprises a top electrode, a piezoelectric layer and a bottom electrode, wherein: the bottom electrode is connected to the substrate; the piezoelectric layer is made of a lead zirconate titanate (PZT); the top electrode is made of at least one of gold and chromium; and the bottom electrode is made of platinum.

While the invention has been described in terms of what is presently considered to be the most practical and preferred embodiments, it is to be understood that the invention need not be limited to the disclosed embodiments. Therefore, it is intended to cover various modifications and similar conFigurations included within the spirit and scope of the appended claims, which are to be accorded with the broadest interpretation so as to encompass all such modifications and similar structures.

What is claimed is:

1. A piezoelectric speaker, comprising:
a frame;
a cantilever plate actuator disposed on the frame;
a spring connected to the frame and the cantilever plate actuator; and
a central diaphragm connected to the spring, wherein when the cantilever plate actuator vibrates, the central diaphragm vibrates with the spring.

2. The piezoelectric speaker as claimed in claim 1, wherein the frame comprises a first silicon layer, a first silicon dioxide layer, a second silicon layer, and a second silicon dioxide layer in order from bottom to top.

3. The piezoelectric speaker as claimed in claim 2, wherein the central diaphragm and the spring are formed of a material the same as that of the first silicon layer of the frame.

4. The piezoelectric speaker as claimed in claim 3, wherein the cantilever plate actuator comprises a top electrode, a piezoelectric layer and a bottom electrode, wherein:
the bottom electrode is connected to the first silicon dioxide layer;
the piezoelectric layer is made of a lead zirconate titanate (PZT);
the top electrode is made of at least one of gold and chromium; and
the bottom electrode is made of platinum.

5. The piezoelectric speaker as claimed in claim 1, wherein the spring is a plate having a plurality of slits.

6. The piezoelectric speaker as claimed in claim 1, wherein the cantilever plate actuator has a fixed end and a vibrating end, the vibrating end is connected to the spring, and the fixed end is connected to the frame.

7. A method for manufacturing a piezoelectric speaker, comprising steps of:
providing a substrate;
forming a bottom electrode layer on the substrate;
forming a piezoelectric layer on the bottom electrode layer, wherein the substrate, the bottom electrode layer and the piezoelectric layer form a precursor having a central region and an edge area;
etching the piezoelectric layer in the edge area;
forming and patterning a top electrode layer on the edge area;
etching the piezoelectric layer, the bottom electrode layer and an upper portion of the substrate located in the central region to form a cantilever plate actuator; and
etching a lower portion of the substrate to form a frame, a spring connected to the frame and the cantilever plate actuator, and a central diaphragm connected to the spring.

8. The method as claimed in claim 7, wherein:
the substrate comprises a first silicon dioxide layer, a first silicon layer, a second silicon dioxide layer and a second silicon layer in order from bottom to top;
the substrate has a lower portion and an upper portion, the lower portion comprises the first silicon dioxide layer and the first silicon layer, and the upper portion comprises the second silicon dioxide layer and the second silicon layer; and
the central diaphragm and the spring are made of a material the same as that of the first silicon layer of the frame.

9. The method as claimed in claim 7, wherein:
the piezoelectric layer is made of a lead zirconate titanate (PZT);
the top electrode layer is made of at least one of gold and chromium; and
the bottom electrode layer is made of platinum.

10. The method as claimed in claim 7, wherein the spring is a plate having a plurality of slits.

11. The method as claimed in claim 7, wherein the cantilever plate actuator has a fixed end and a vibrating end, the vibrating end is connected to the spring, and the fixed end is connected to the frame.

12. A piezoelectric speaker, comprising:
a piezoelectric element; and
a substrate carrying thereon the piezoelectric element, and comprising:
a central diaphragm disposed in the center of the substrate to generate a second vibration in response to a first vibration of the piezoelectric element; and
an amplitude enhancement mechanism disposed on the central diaphragm to enhance a vibration amplitude of the second vibration.

13. The piezoelectric speaker as claimed in claim 12, wherein the amplitude enhancement mechanism is formed by a specific slot pattern.

14. The piezoelectric speaker as claimed in claim 12, wherein the central diaphragm and the amplitude enhancement mechanism are formed of a material the same as that of the substrate.

15. The piezoelectric speaker as claimed in claim 12, wherein the piezoelectric element has a fixed end and a vibrating end, the vibrating end is connected to the amplitude enhancement mechanism, and the fixed end is connected to the substrate.

16. The piezoelectric speaker as claimed in claim 12, wherein the piezoelectric element comprises a top electrode, a piezoelectric layer and a bottom electrode, wherein:
the bottom electrode is connected to the substrate;
the piezoelectric layer is made of a lead zirconate titanate (PZT);
the top electrode is made of at least one of gold and chromium; and
the bottom electrode is made of platinum.
